(19) United States
(12) Patent Application Publication
(10) Pub. No.: US 2011/0133686 A1
(43) Pub. Date: Jun. 9, 2011

(54) BATTERY DEVICE

(75) Inventors: Cheng Wang, Hsinchu County (TW); Nien-Hui Hsu, Hsinchu County (TW); Po-Kuei Chou, Hsinchu County (TW); Kuo-Tai Hung, Hsinchu County (TW); Shin-Ping Kung, Hsinchu County (TW); Wan-Chin Chao, Hsinchu County (TW); Yu-Tzu Wu, Hsinchu County (TW); Shao-Chi Huang, Hsinchu County (TW)

(73) Assignee: YOUNG GREEN ENERGY CO., Hsinchu County (TW)

(21) Appl. No.: 12/858,444

(22) Filed: Aug. 18, 2010

(30) Foreign Application Priority Data
Dec. 4, 2009 (CN) 200910253653.X

(51) Int. Cl. H01M 10/46; H01M 12/08

(52) U.S. Cl. 320/101; 429/9

(57) ABSTRACT

A battery device for a notebook computer includes a control circuit, a rechargeable battery unit, and a fuel cell unit. The control circuit includes a transmission interface adapted to be electrically connected to the notebook computer. The rechargeable battery unit is electrically connected to the control circuit and includes a plurality of battery cells. The fuel cell unit is electrically connected to the control circuit. A volume of the fuel cell unit is substantially integral multiple of a volume of the battery cell.

### CROSS-REFERENCE TO RELATED APPLICATION

This application claims the priority benefit of China application serial no. 200910253653.X, filed on Dec. 4, 2009. The entirety of the above-mentioned patent application is hereby incorporated by reference herein and made a part of this specification.

### BACKGROUND OF THE INVENTION

1. Field of the Invention

The invention relates to a battery device, and more particularly, to a battery device that includes both a rechargeable battery unit and a fuel cell unit.

2. Description of Related Art

Li-ion batteries are currently the major power storage devices for portable electronic devices. Taking a notebook computer as an example, the stored power is supplied to the notebook computer from a plurality of rechargeable battery cells that are connected in series or in parallel.

FIG. 1 is a block diagram of a conventional battery device. Referring to FIG. 1, the battery device 100 includes two rechargeable battery units 110 and a control circuit 120. The rechargeable battery unit 110 is, for example, a Li-ion battery, which includes a plurality of orderly arranged battery cells 112 connected with one another. Six battery cells 112 are illustrated herein, with each three battery cells 112 connected in series to form a rechargeable battery unit 110. The two rechargeable battery units 110, which are arranged in parallel, are connected to a control circuit 120. The battery device 100 may be assembled to a notebook computer 200 and supply power to the notebook computer 200 through a transmission interface 122 of the control circuit 120.

However, this type of rechargeable battery device provides a limited power. After providing power for a certain period of time, one needs to use a backup battery or power cable to maintain normal operation of the notebook computer. This imposes a burden of carrying the backup battery or power cable on the user or the user may encounter a situation where no power supply is available. What is needed, therefore, is a battery device with an extended battery life.

### SUMMARY OF THE INVENTION

Accordingly, the invention is directed to a battery device for a notebook computer.

Other objectives and advantages of the invention could further comprehended from the technical features disclosed in the invention.

One embodiment of the invention provides a battery device for a notebook computer. The battery device includes a control circuit, a rechargeable battery unit, and a fuel cell unit. The control circuit includes a transmission interface adapted to be electrically connected to the notebook computer. The rechargeable battery unit is electrically connected to the control circuit and includes a plurality of battery cells. The fuel cell unit is electrically connected to the control circuit. A volume of the fuel cell unit is substantially integral multiple of a volume of the battery cell.

Another embodiment of the invention provides a battery device for a notebook computer. The battery device includes a control circuit, a rechargeable battery unit, and a fuel cell unit. The control circuit includes a transmission interface adapted to be electrically connected to the notebook computer. The rechargeable battery unit is electrically connected to the control circuit and includes a plurality of orderly arranged battery cells. The fuel cell unit is electrically connected to the control circuit. A projection area of the fuel cell unit on a plane on which the battery cells are arranged is substantially integral multiple of a projection area of the battery cell on the plane. A projection area of the fuel cell unit on an orthogonal plane that is orthogonal to the plane on which the battery cells are arranged is substantially equal to a projection area of the battery cell on the orthogonal plane.

In view of the foregoing, at least one of the above embodiments of the invention may have at least one of the following advantages. The volume of the fuel cell is substantially equal to the volume of the rechargeable battery. This allows the battery device to contain both the rechargeable battery unit and the fuel cell unit to increase the service life of the battery device without increasing the size of the battery device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional battery device.

FIG. 2 is a block diagram of a battery device according to one embodiment of the invention.

FIG. 3 and FIG. 4 are side views of the battery devices of FIG. 1 and FIG. 2, respectively.

FIG. 5 and FIG. 6 are block diagrams of a battery device according to alternative embodiments of the invention, respectively.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purposes of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

FIG. 2 is a block diagram of a battery device according to one embodiment of the invention. Referring to FIG. 2, in the present embodiment, the battery device 300 includes a fuel cell unit 330, a control circuit 320, and a rechargeable battery unit 110. The control circuit 320 includes a transmission interface 122. The fuel cell unit 330 and the rechargeable battery unit 110 are connected to the control circuit 320 in parallel. In the present embodiment, the fuel cell unit 330 is, for example, a proton exchange membrane fuel cell (PEMFC) unit or a direct methanol fuel cell (DMFC) unit, which produces electricity through the reaction between a fuel and a catalyst. However, this invention is not limited to it.

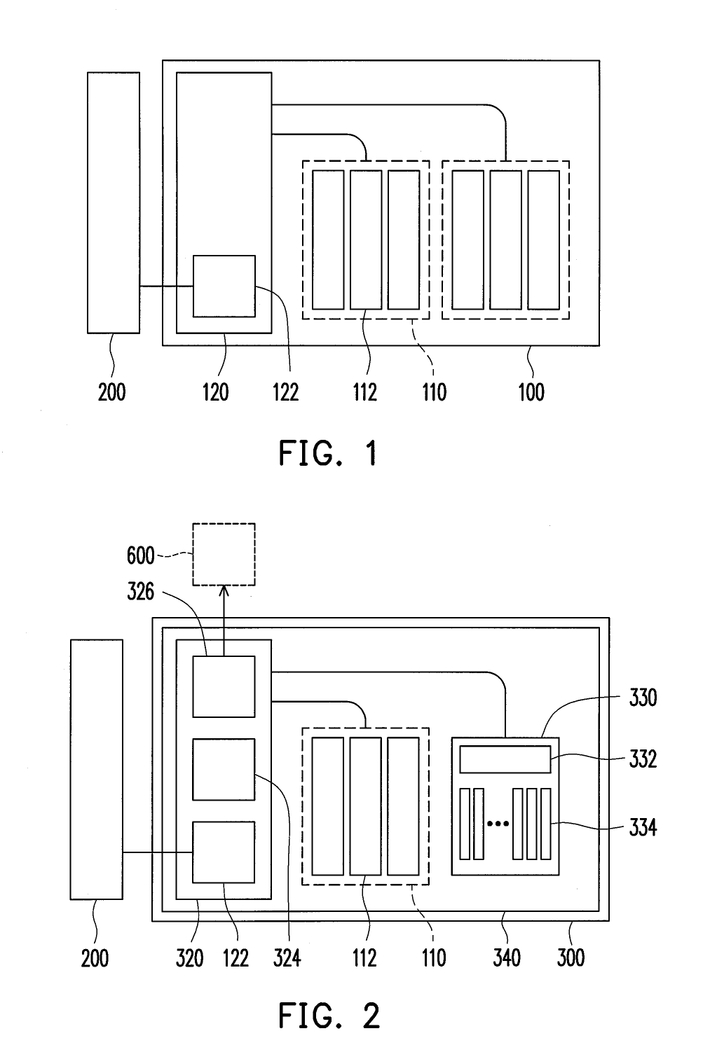

Referring to FIG. 1 and FIG. 2, in the embodiment of FIG. 2, power is supplied to a notebook computer 200 through the transmission interface 122 of the control circuit 320, which is the same as the conventional battery device of FIG. 1. The difference lies in that the fuel cell unit 330 and the rechargeable battery unit 110 that is the fuel cell unit 330 integrated into the battery device 300, such that the capacity of the battery device 300 is significantly increased in comparison with the battery device 100 with the fuel cell unit 330. More importantly, the fuel cell unit 330 replaces a part of the rechargeable battery unit 100 in the battery device 300 and the volume of the fuel cell unit 330 is substantially integral multiple of a volume of a battery cell 112.

For example, the volume of the fuel cell unit 330 of FIG. 2 in the battery device 300 is almost three times of the volume of the battery cell 112 of FIG. 1. That is, in this embodiment, the volume of the fuel cell unit 330 is 70% to 150% of the volume of one rechargeable battery unit 110. In other words, the volume of the fuel cell unit 330 is substantially equal to the volume of one rechargeable battery unit 110 and the capacity of the fuel cell unit 330 is greater than or equal to the capacity of the rechargeable battery unit 110.

In other words, in the embodiment of FIG. 2, the fuel cell unit 330 may be used to replace one rechargeable battery unit 110 of FIG. 1. Since the fuel cell unit 330 does not occupy additional volume in the battery device 300, the battery device 300 still maintain the same size as the battery device 100 while the capacity may be significantly increased due to a continuous supply of power from the fuel cell unit 330, and the service life of the battery device 300 will increase thereby.

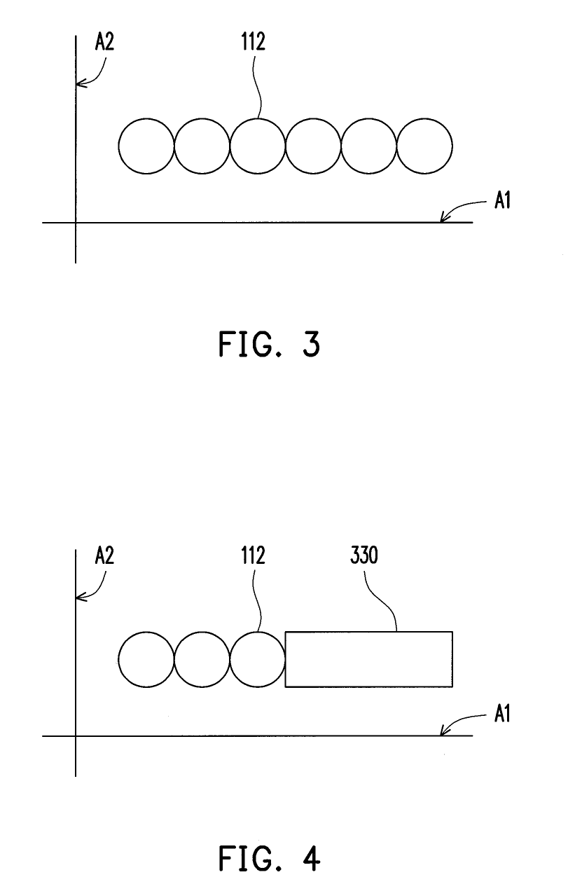

FIG. 3 and FIG. 4 are side views of the battery devices of FIG. 1 and FIG. 2, respectively. A further comparative description of the volume of the fuel cell unit 330 of FIG. 2 and the rechargeable battery unit 110 of FIG. 1 is made below with reference to FIG. 3 and FIG. 4. Referring to FIG. 3 and FIG. 4, in the present embodiment, a projection area of the fuel cell unit 330 on a plane A1 on which the battery cells 112 are arranged is substantially integral multiple of a projection area of the battery cells 112 on the plane A1. In addition, a projection area of the fuel cell unit 330 on an orthogonal plane A2 that is orthogonal to the plane A1 is substantially equal to a projection area of the battery cell 112 on this orthogonal plane A2. Therefore, from FIG. 3 and FIG. 4, it may be apparent that the volume of the fuel cell unit 330 is substantially equal to the volume of three battery cells 112.

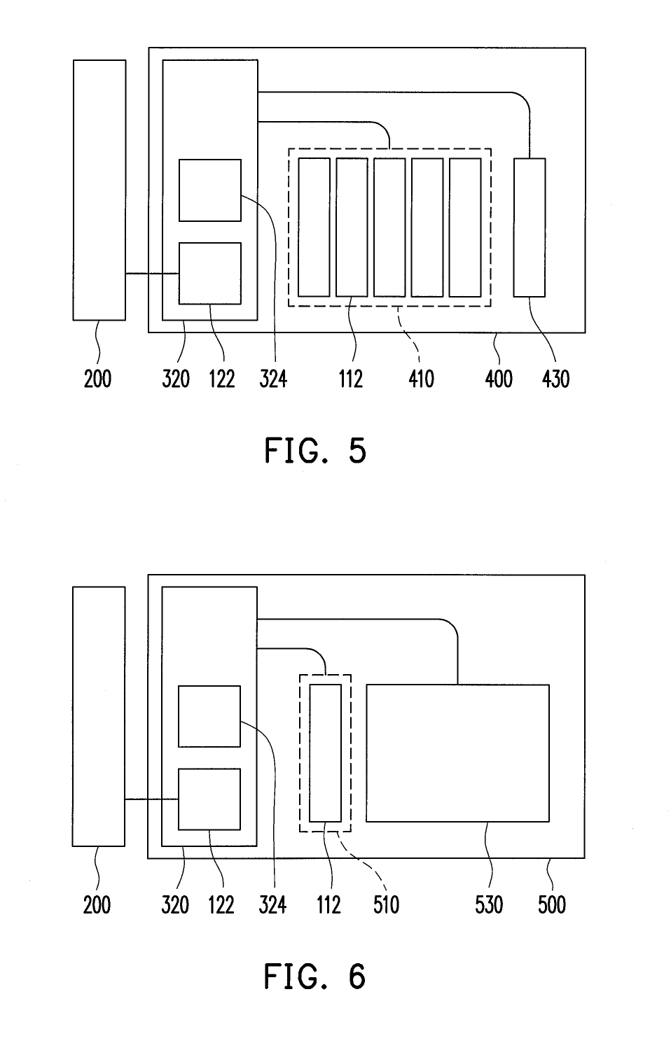

However, the present embodiment is not intended to limit the volume of the fuel cell unit 330 and the number of the battery cells 112 to any particulars disclosed herein. FIG. 5 and FIG. 6 are block diagrams of a battery device according to alternative embodiments of the invention, respectively. Referring first to FIG. 5, in the battery device 400 of the embodiment, a rechargeable battery unit 410 includes five battery cells 112. Therefore, the volume of the fuel cell unit 430 is substantially equal to the volume of one battery cell 112. In addition, in the battery device 500 of FIG. 6, a rechargeable battery unit 510 includes one battery cell 112. Therefore, the volume of the fuel cell unit 530 is substantially equal to the volume of five battery cells 112. As such, one may choose a suitable combination of the fuel cell unit and the rechargeable battery unit based on the power requirement of the notebook computer 200.

Referring to FIG. 2, in the present embodiment, the battery device 300 further includes an outer housing 340 for accommodating the fuel cell unit 330, rechargeable battery unit 110, and control circuit 320 disclosed above. In addition, the fuel cell unit 330 includes a fuel tank 332 and a plurality of fuel cells 334. The fuel tank 332 is used for storage of fuel (e.g. methanol or solid sodium borohydride) and detachably connected the fuel cells 334. Therefore, the fuel cell unit 330 may continuously supply power by replacing the fuel tank 332. The capacity provided by the fuel tank 332 of the fuel cell unit 330 is greater than or equal to the capacity of the replaced rechargeable battery unit 110 of FIG. 1. In addition, when the battery device 300 is assembled to the notebook computer 200 and the oxygen is used as one of the fuels, a heat dissipation system (not shown) of the notebook computer 200, such as, a fan, an air inlet or an outlet, may be used to provide the oxygen needed for operation of the fuel cell unit 330.

In addition, in the embodiment, the fuel cell unit 330 may be controlled by the control circuit 320 to not only directly supply power to the notebook computer 200 but also recharge the rechargeable battery unit 110. Accordingly, the control circuit 320 includes a transforming unit 324 such as a direct current transformer for transforming the voltage of the fuel cell unit 330 into a voltage that is provided to recharge the rechargeable battery unit 110 for achieving the purposes described above.

On the other hand, in the embodiment of the fuel cell unit 330 provides the capacity correspond with the capacity of the replaced battery cells 112, in the embodiment, the recharge voltage of the battery cell 112 is 3.2 to 4.2 V in the case of Li-ion battery cell. When the supply voltage of the fuel cell 334 is 0.35 to 0.7 V, the number of the fuel cells 334, the voltage of each of the fuel cells 334, the number of the battery cells 112, and the voltage of each of the battery cells 112 may satisfy the following relationship:

(6×N−2)×V<M×W<(8×N+6)×V,

where, M represents the number of the battery cells 112, N represents the number of the fuel cells 334, W represents the voltage of the battery cell, and V represents the voltage of the fuel cell. Taking the embodiment of FIG. 2 as an example, when the rechargeable battery unit 110 includes three battery cells 112, it is necessary to arrange 16 to 28 fuel cells 334 in the fuel cell unit 330. If the number of fuel cells 334 is larger, the supply voltage of the fuel cell unit 330 is substantially equal to the recharge voltage of the rechargeable battery unit 110 accordingly, and thus the transforming unit 324 disclosed above may be eliminated.

In addition, referring to FIG. 2, the control circuit 320 further includes a connector 326 such as a universal serial bus (USB). Therefore, the fuel cell unit 330 may recharge another portable electronic device 600 thus the applications of the battery device 300 become wider. Alternatively, this connector 326 may also be connected to a connector (not shown) of the notebook computer 200 such that software in the notebook computer 200 may be used to control the control circuit 320.

In summary, at least one of the embodiments of the invention may have at least one of the following advantages. The battery device contains both the fuel cell unit and the rechargeable battery unit, and the volume of the fuel cell unit is substantially integral multiple of the volume of the battery cell in the rechargeable battery unit. Therefore, the volume of the fuel cell unit in the battery device is substantially equal to the volume of the replaced rechargeable battery unit. This allows the battery device to effectively increase its capacity by including the fuel cell to thereby increase the service life of the battery device without increasing the size and additional design.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A battery device for a notebook computer, the battery device comprising:
a control circuit comprising a transmission interface adapted to be electrically connected to the notebook computer;
a rechargeable battery unit electrically connected to the control circuit and comprising a plurality of battery cells; and
a fuel cell unit electrically connected to the control circuit, a volume of the fuel cell unit being substantially integral multiple of a volume of the battery cell.

2. The battery device according to claim 1, wherein the volume of the fuel cell unit is substantially equal to the volume of the rechargeable battery unit.

3. The battery device according to claim 1, wherein the volume of the fuel cell unit is 70% to 150% of the volume of the rechargeable battery unit.

4. The battery device according to claim 1, wherein the capacity of the fuel cell unit is greater than or equal to the capacity of the rechargeable battery unit with the same volume as the fuel cell unit.

5. The battery device according to claim 1, wherein the fuel cell unit comprises a plurality of fuel cells, the number of the fuel cells, the voltage of each of the fuel cells, and the number of the battery cells and the voltage of each of the battery cells satisfy the following relationship:
(6×N−2)×V<M×W<(8×N+6)×V,
where M represents the number of the battery cells, N represents the number of the fuel cells, W represents the voltage of each battery cell, and V represents the voltage of each fuel cell.

6. The battery device according to claim 5, wherein the fuel cell unit further comprises a fuel tank detachably connected to the fuel cells.

7. The battery device according to claim 6, wherein the capacity of the fuel tank of the fuel cell unit is greater than or equal to the capacity of the rechargeable battery unit.

8. The battery device according to claim 1, wherein the control circuit further comprises a transforming unit for transforming the voltage of the fuel cell unit into a voltage that is provided to recharge the rechargeable battery unit.

9. A battery device for a notebook computer, the battery device comprising:
a control circuit including a transmission interface adapted to be electrically connected to the notebook computer;
a rechargeable battery unit electrically connected to the control circuit and comprising a plurality of orderly arranged battery cells; and
a fuel cell unit electrically connected to the control circuit, wherein a projection area of the fuel cell unit on a plane on which the battery cells are arranged being substantially integral multiple of a projection area of the battery cell on the plane, a projection area of the fuel cell unit on an orthogonal plane that is orthogonal to the plane on which the battery cells are arranged being substantially equal to a projection area of the battery cell on the orthogonal plane.

10. The battery device according to claim 9, wherein the fuel cell unit comprises a plurality of fuel cells, and the number of the fuel cells, the voltage of each of the fuel cells, the number of the battery cells, and the voltage of each of the battery cells satisfy the following relationship:
(6×N−2)×V<M×W<(8×N+6)×V,
where M represents the number of the battery cells, N represents the number of the fuel cells, W represents the voltage of each battery cell, and V represents the voltage of each fuel cell.

11. The battery device according to claim 10, wherein the fuel cell unit further comprises a fuel tank detachably connected to the fuel cells.

12. The battery device according to claim 11, wherein the capacity of the fuel tank of the fuel cell unit is greater than or equal to the capacity of the rechargeable battery unit.

13. The battery device according to claim 9, wherein the capacity of the fuel cell unit is greater than or equal to the capacity of the rechargeable battery unit with the same volume as the fuel cell unit.

14. The battery device according to claim 9, wherein the control circuit further comprises a transforming unit for transforming the voltage of the fuel cell unit into a voltage that is provided to recharge the rechargeable battery unit.
